(19) United States
(12) Patent Application Publication
(10) Pub. No.: US 2013/0162545 A1
(43) Pub. Date: Jun. 27, 2013

(54) SENSING ELECTRODE PATTERN OF TOUCH PANEL

(71) Applicants: Youn Soo KIM, Seoul (KR); Young Jae KIM, Gynggi-do (KR); Ha Yoon SONG, Gyunggi-do (KR); Ho Joon PARK, Seoul (KR)

(72) Inventors: Youn Soo KIM, Seoul (KR); Young Jae KIM, Gynggi-do (KR); Ha Yoon SONG, Gyunggi-do (KR); Ho Joon PARK, Seoul (KR)

(73) Assignee: SAMSUNG ELECTRO-MECHANICS CO., LTD., Gyunggi-do (KR)

(21) Appl. No.: 13/427,840

(22) Filed: Mar. 22, 2012

(30) Foreign Application Priority Data
Dec. 26, 2011 (KR) 10-2011-0142572

(51) Int. Cl. G06F 3/041

(52) U.S. Cl. 345/173

(57) ABSTRACT

Disclosed herein is a sensing electrode pattern of a touch panel. The sensing electrode pattern of the touch panel includes a plurality of sensing electrodes disposed in parallel to each other; and a plurality of auxiliary electrodes extending from lateral surfaces of each sensing electrode.

### CROSS REFERENCE TO RELATED APPLICATION

This application claims the benefit of Korean Patent Application No. 10-2011-0142572, filed on Dec. 26, 2011, entitled “Sensing Electrode Pattern”, which is hereby incorporated by reference in its entirety into this application.

### BACKGROUND OF THE INVENTION

1. Technical Field

The present invention relates to a sensing electrode pattern of a touch panel.

2. Description of the Related Art

As computers using digital technologies have been developed, auxiliary devices of computers have been developed together. A personal computer, a portable transmitting device, other personal information processing devices, or the like processes texts and graphics by using various input devices such as keyboards and mouse.

By virtue of rapid development of information-oriented society, the use of a computer has been gradually spread. However, it is difficult to effectively drive a product by simply using a keyboard and a mouse that currently serve as an input device. Thus, there is an increasing need for a device for facilitating simple manipulation, preventing wrong manipulation, and allowing anyone to easily input information.

With regard to technologies related to an input device, attention has been changed from technologies for satisfying requirements for general functions to technologies for high reliability, durability, and innovativeness, technologies related to design and process, and the like. To this end, a touch panel has been developed as an input device facilitating an input of information such as a text, a graphic, or the like.

A touch panel is a tool that is installed on a display surface of a flat display device such as a portable terminal, an electronic notebook, a liquid crystal display device (LCD), a plasma display panel (PDP), an electroluminescence (El), or the like or a display surface of an image display device such as a cathode ray tube (CRT) and is used when a user selects desired information while viewing an image display device.

A touch panel is classified into a resistive-type touch panel, a capacitive-type touch panel, an electromagnetic-type touch panel, a surface acoustic wave (SAW)-type touch panel, and an infrared-type touch panel. These various types of touch panels are used in electronic products in consideration of a signal amplification issue, a difference in resolutions, a difficulty of design and process technologies, optical properties, electrical properties, mechanical properties, environmental properties, input properties, durability, and economic efficiency. In this regard, a touch panel that has been getting the spotlight is a multi-touch capacitive-type touch panel.

A capacitive-type touch panel includes a driving electrode and a sensing electrode and detects a change in electrostatic capacity when a user inputs a touch signal.

In this case, the sensing electrode generates a signal when a user touches the touch panel such that a controller may recognize the touch signal in a touch coordinate

However, as a touch panel gradually increases in size, a large number of sensing electrode patterns (i.e., the number of channels) are required. Thus, an integrated circuit (IC) for receiving and processing a touch signal of a sensing electrode requires a high capacity and power consumption is increased.

### SUMMARY OF THE INVENTION

The present invention has been made in an effort to provide a sensing electrode pattern of a touch panel, by which a touch panel of a large size may be covered by a small number of sensing electrodes.

Further, the present invention has been made in an effort to provide a sensing electrode pattern of a touch panel, for minutely detecting a touch input between sensing electrodes when a user touches the touch panel.

According to a preferred embodiment of the present invention, there is provided a sensing electrode pattern of a touch panel, including: a plurality of sensing electrodes disposed in parallel to each other; and a plurality of auxiliary electrodes extending from lateral surfaces of each sensing electrode.

The plurality of sensing electrodes may each be formed to have a linear bar shape.

The plurality of auxiliary electrodes may be arranged by a predetermined interval in a longitudinal direction of the plurality of sensing electrodes of the touch panel.

The plurality of auxiliary electrodes may be alternately formed, wherein auxiliary electrodes formed on adjacent sensing electrodes may be alternately disposed.

The plurality of sensing electrodes and the plurality of auxiliary electrodes may be formed of a conductive polymer or a metal oxide.

The plurality of auxiliary electrodes may each be formed to have a triangular plate shape.

The plurality of auxiliary electrodes may be formed such that a width of each auxiliary electrode may taper away from each sensing electrode.

The plurality of auxiliary electrodes may each be formed to have a linear bar shape.

An end of each auxiliary electrode may be formed to have a circular plate shape.

Each auxiliary electrode may be bent at a predetermined angle.

### BRIEF DESCRIPTION OF THE DRAWINGS

FIG. 1 is a plan view of a sensing electrode pattern of a touch panel, according to an embodiment of the present invention;

FIG. 2 is a cross-sectional view of the sensing electrode pattern of the touch panel of FIG. 1, according to an embodiment of the present invention;

FIG. 3 is a plan view of a sensing electrode pattern of a touch panel, according to another embodiment of the present invention;

FIG. 4 is a plan view of a sensing electrode pattern of a touch panel, according to another embodiment of the present invention; and

FIG. 5 is a plan view of a sensing electrode pattern of a touch panel, according to another embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

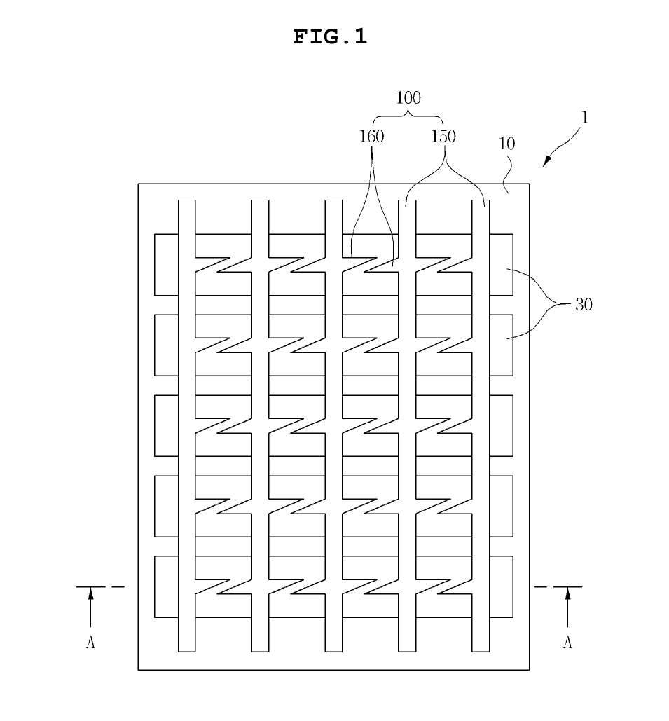

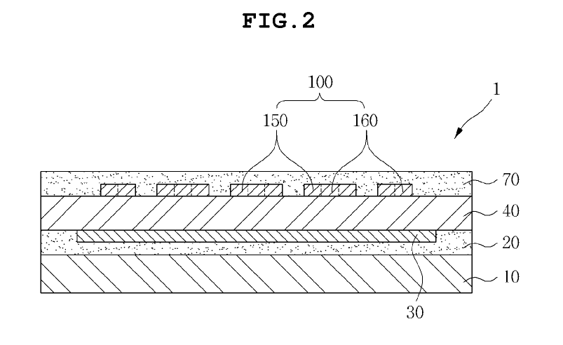

FIG. 1 is a plan view of a sensing electrode pattern 100 of a touch panel 1, according to an embodiment of the present invention. FIG. 2 is a cross-sectional view of the sensing electrode pattern 100 of the touch panel 1 of FIG. 1, according to an embodiment of the present invention.

Referring to FIGS. 1 and 2, the sensing electrode pattern 100 of the touch panel 1 includes a plurality of sensing electrodes 150 and a plurality of auxiliary electrodes 160 extending from each sensing electrode 150.

Hereinafter, the sensing electrode pattern 100 of the touch panel 1 will be described in more detail with reference to FIGS. 1 and 2.

Referring to FIGS. 1 and 2, the sensing electrodes 150 are arranged in parallel to each other on a surface of a transparent substrate 40 of the touch panel 1.

In this case, each sensing electrode 150 may be formed to have a linear bar shape. In this case, the linear bar shape may be, for example, a rectangular plate shape. However, the shape of the sensing electrode 150 according to the present embodiment is not limited thereto.

In addition, the touch panel 1 includes a driving electrode pattern 30 and the sensing electrode pattern 100. In this case, when a user touches the touch panel 1, the driving electrode pattern 30 and the sensing electrode pattern 100 may generate a signal such that a controller may recognize the signal in a touch coordinate. When a voltage is applied to the driving electrode pattern 30, an electric field is formed in the sensing electrode pattern 100 through the driving electrode pattern 30. In this case, when the sensing electrode pattern 100 is touched by an object, since the amount of charges may be reduced, the controller may determine that the sensing electrode pattern 100 is touched.

In addition, the touch panel 1 may include the transparent substrate 40. The driving electrode pattern 30 and the sensing electrode pattern 100 may be formed on two surfaces of the transparent substrate 40. In this case, a first insulating layer 20 and a second insulating layer 70 may be respectively formed on the driving electrode pattern 30 and the sensing electrode pattern 100 by using a coating method. In this case, a base substrate 10 may be disposed on a first surface of the lint insulating layer 20 and the driving electrode pattern 30 may be disposed on a second surface of the first insulating layer 20. The driving electrode pattern 30 may be formed to have a linear bar shape. In this case, the linear bar shape may be, for example, a rectangular plate shape.

The driving electrode pattern 30 and the sensing electrode pattern 100 may each be formed of a conductive polymer or a metal oxide.

In addition, a conductive polymer has high flexibility and makes a coating process easier. In this case, the conductive polymer may include poly-3,4-ethylenedioxythiophene/polystyrenesulfonate (PEDOT/PSS), polyaniline, polyacetylene, or polyphenylenevinylene.

In addition, the metal oxide includes indium-tin oxide (ITO).

The driving electrode pattern 30 and the sensing electrode pattern 100 may be formed by using a dry process, a wet process, or a direct patterning process. Examples of the dry process include sputtering, evaporation, and the like. Examples of the wet process include dip coating, spin coating, roll coating, and spray coating. Examples of the direct patterning process include screen printing, gravure printing, and inkjet printing.

In addition to the above-described metals, the driving electrode pattern 30 or the sensing electrode pattern 100 may be formed metallic silver obtained by exposing/developing a silver salt emulsion layer.

In addition, the transparent substrate 40 needs to have a bearing capacity for supporting the driving electrode pattern 30 and the sensing electrode pattern 100 and transparency for allowing a user to recognize an image displayed on an image display device. In consideration of the bearing capacity and the transparency, the transparent substrate 40 may be formed of, but is not limited to, any one of polyethyleneterephthalate (PET), polycarbonate (PC), polymethyl methacrylate (PMMA), polyethylenenaphthalate (PEN), polyethersulfone (PES), cyclic olefin copolymer (COC), triacetylcellulose (TAC), polyvinyl alcohol (PVA), polyimide (PI), polystyrene (PS), K resin-containing biaxially oriented polystyrene (BOPS), glass, tempered glass, or the like.

In order to activate two surfaces of the transparent substrate 40, high-frequency treatment or primer treatment may be performed on the two surfaces of the transparent substrate 40. By activating the two surfaces of the transparent substrate 40, adhesion between the transparent substrate 40 and the driving electrode pattern 30 and adhesion between the transparent substrate 40 and the sensing electrode pattern 100 may be increased.

The present embodiment is not limited to the case where a driving electrode and the sensing electrodes 150 are respectively formed on only the two surfaces of the transparent substrate 40. For example, a plurality of transparent substrates 40 may be formed and the driving electrode pattern 30 and the sensing electrode pattern 100 are formed on each of the transparent substrates 40. Alternatively, the transparent substrate 40 may be formed to have a window such that the driving electrode pattern 30 and the sensing electrode pattern 100 may be integrated with the window.

Referring to FIGS. 1 and 2, the auxiliary electrodes 160 may extend from lateral surfaces of each sensing electrode 150.

In addition, the auxiliary electrodes 160 are arranged by a predetermined interval in a longitudinal direction of the sensing electrodes 150. In this case, the auxiliary electrodes 160 are formed on the lateral surfaces of each of the sensing electrodes 150. The auxiliary electrodes 160 that extend from adjacent sensing electrodes 150 are alternately disposed.

The auxiliary electrodes 160 may be formed of the same material as the sensing electrodes 150. In this case, the auxiliary electrodes 160 may be formed of, for example, a conductive polymer or a metal oxide.

Further, the auxiliary electrodes 160 may be formed to have a triangular plate shape such that a width of the auxiliary electrode 160 may taper away from each sensing electrode 150.

Due to the auxiliary electrodes 160 extending from each sensing electrode 150, the sensing electrode pattern 100 of the touch panel 1 according to the present embodiment may minutely detect a touch input between the sensing electrodes 150. Thus, since the number of the sensing electrodes 150 may be reduced, power consumption of the touch panel 1 may be reduced and a low-capacity integrated circuit (IC) may be used.

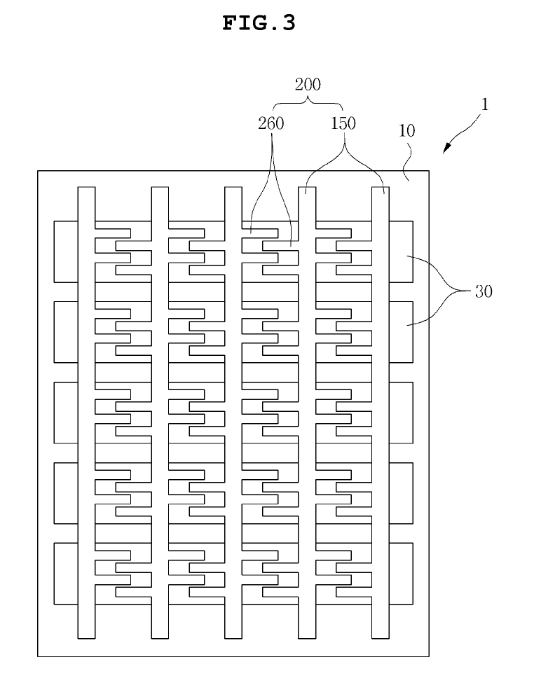

FIG. 3 is a plan view of a sensing electrode pattern 200 of a touch panel 1, according to another embodiment of the present invention.

The sensing electrode pattern 200 of the touch panel 1 includes a plurality of sensing electrodes 150 and a plurality of auxiliary electrodes 260 extending from lateral surfaces of each sensing electrode 150.

The sensing electrode pattern 200 of the touch panel 1 of FIG. 3 is different from the sensing electrode pattern 100 of the touch panel 1 of FIGS. 1 and 2 in terms of a shape of the auxiliary electrodes 260. Thus, a repeated explanation of the elements as elements shown in FIGS. 1 and 2 will be simply described and the sensing electrode pattern 200 of the touch panel 1 of FIG. 3 will be described in terms of differences from the sensing electrode pattern 100 of the touch panel 1 of FIGS. 1 and 2. In addition, the same elements are denoted by the same reference numerals, in FIGS. 1 through 3.

Referring to FIG. 3, the auxiliary electrodes 260 extend from the lateral surfaces of each sensing electrode 150.

The auxiliary electrodes 260 are arranged by a predetermined interval in a longitudinal direction of the sensing electrodes 150. In this case, the auxiliary electrodes 260 are formed on the lateral surfaces of each sensing electrode 150. The auxiliary electrodes 260 that extend from adjacent sensing electrodes 150 are alternately disposed.

The auxiliary electrodes 260 may be formed of the same material as the sensing electrodes 150. In this case, the auxiliary electrodes 260 may be formed of, for example, a conductive polymer or a metal oxide.

The auxiliary electrodes 260 may extend from each sensing electrode 150 to have each a linear bar shape. In this case, the linear bar shape may be, for example, a rectangular plate shape.

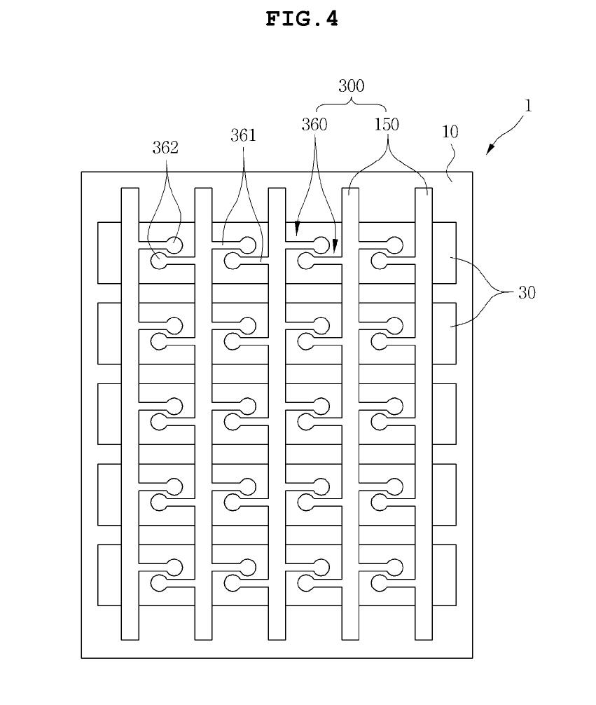

FIG. 4 is a plan view of a sensing electrode pattern 300 of a touch panel 1, according to another embodiment of the present invention.

The sensing electrode pattern 300 of the touch panel 1 includes a plurality of sensing electrodes 150 and a plurality of auxiliary electrodes 360 extending from lateral surfaces of each sensing electrode 150.

The sensing electrode pattern 300 of the touch panel 1 of FIG. 4 is different from the sensing electrode patterns 100 and 200 of the touch panel 1 of FIGS. 1 and 2, and 3 in terms of a shape of the auxiliary electrodes 360. Thus, a repeated explanation of the elements as elements shown in FIGS. 1 through 3 will be simply described and the sensing electrode pattern 300 of the touch panel 1 of FIG. 4 will be described in terms of differences from the sensing electrode patterns 100 and 200 of the touch panel 1 of FIGS. 1 and 2, and 3. In addition, the same elements are denoted by the same reference numerals, in FIGS. 1 through 4.

Referring to FIG. 4, the auxiliary electrodes 360 extend from the lateral surfaces of each sensing electrode 150.

The auxiliary electrodes 360 are arranged by a predetermined interval in a longitudinal direction of the sensing electrodes 150. In this case, the auxiliary electrodes 360 are formed on the lateral surfaces of each sensing electrode 150. The auxiliary electrodes 360 that extend from adjacent sensing electrodes 150 are alternately disposed.

The auxiliary electrodes 360 may be formed of the same material as the sensing electrodes 150. In this case, the auxiliary electrodes 360 may be formed of, for example, a conductive polymer or a metal oxide.

Further, each auxiliary electrode 360 includes support electrodes 361 that each extend from the sensing electrodes 150 to have a linear bar shape and circular electrodes 362 that are respectively formed at ends of the support electrodes 361 to have a circular plate shape. In this case, a width (i.e., a diameter) of each circular electrode 362 may be greater than a width (i.e., a diameter) of each support electrode 361, thereby preventing sensitivity from being reduced toward an ends of each support electrode 361.

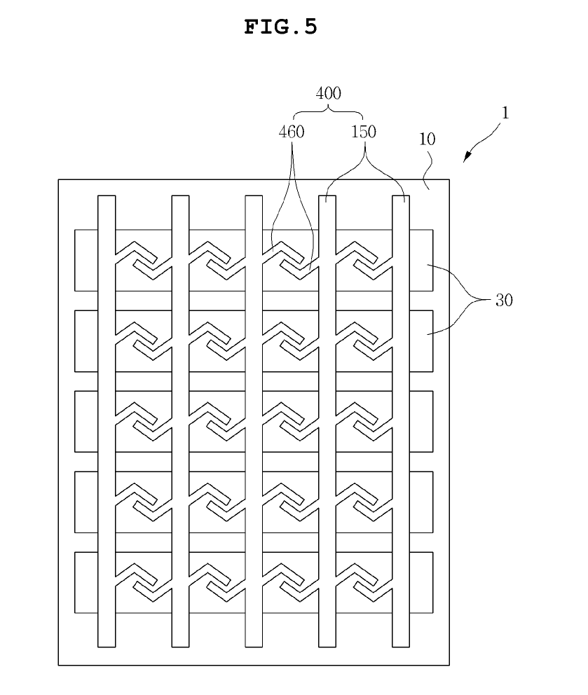

FIG. 5 is a plan view of a sensing electrode pattern 400 of a touch panel 1, according to another embodiment of the present invention.

The sensing electrode pattern 400 of the touch panel 1 includes a plurality of sensing electrodes 150 and a plurality of auxiliary electrodes 460 formed on lateral surfaces of each sensing electrode 150.

The sensing electrode pattern 400 of the touch panel 1 of FIG. 5 is different from the sensing electrode patterns 100, 200, and 300 of the touch panel 1 of FIGS. 1 and 2, 3, and 4 in terms of a shape of the auxiliary electrodes 460. Thus, a repeated explanation of the elements as elements shown in FIGS. 1 through 4 will be simply described and the sensing electrode pattern 400 of the touch panel 1 of FIG. 5 will be described in terms of differences from the sensing electrode patterns 100, 200, and 300 of the touch panel 1 of FIGS. 1 and 2, 3, and 4. In addition, the same elements are denoted by the same reference numerals, in FIGS. 1 through 5.

Referring to FIG. 5, each auxiliary electrode 460 extends from the lateral surfaces of each sensing electrode 150.

The auxiliary electrodes 460 are arranged by a predetermined interval in a longitudinal direction of the sensing electrodes 150. In this case, the auxiliary electrodes 460 are formed on the lateral surfaces of each sensing electrode 150. The auxiliary electrodes 460 that extend from adjacent sensing electrodes 150 are alternately disposed.

The auxiliary electrodes 460 may be formed of the same material as the sensing electrodes 150. In this case, the auxiliary electrodes 460 may be formed of, for example, a conductive polymer or a metal oxide.

Further, the auxiliary electrodes 460 extends from each sensing electrode 150 to have a linear bar shape and are each bent at a predetermined angle.

In this case, each auxiliary electrode 460 includes a first side portion and a second side portion that are formed to make a predetermined angle, for example, from 100 to 130° . However, the angle between the first and second side portions of each auxiliary electrode 460 is not limited thereto.

In this case, the second side portions of the auxiliary electrodes 460 that extend from adjacent sensing electrodes 150 may be alternatively disposed in parallel to each other.

According to the present invention, since a small number of sensing electrodes may cover a touch panel of a large size, a low-capacity integrated circuit (IC) may be used and power consumption of the touch panel may be reduced.

Further, since a small number of sensing electrodes may cover a touch panel of a large size, the number of electrode wirings for connection with the sensing electrodes may be reduced.

In addition, when a user inputs a touch signal, a touch panel may minutely detect a touch input between sensing electrodes such that a touch may be accurately recognized.

Although the preferred embodiments of the present invention have been disclosed for illustrative purposes, they are for specifically explaining the present invention. Therefore, a sensing electrode pattern of a touch panel according to the preferred embodiments of the present invention is not limited thereto, but those skilled in the art will appreciate that various modifications and alteration are possible, without departing from the scope and spirit of the invention as disclosed in the accompanying claims.

Accordingly, such modifications and alterations should also be understood to fall within the scope of the present invention. A specific protective scope of the present invention could be defined by accompanying claims

What is claimed is:

1. A sensing electrode pattern of a touch panel, comprising:
a plurality of sensing electrodes disposed in parallel to each other; and
a plurality of auxiliary electrodes extending from lateral surfaces of each sensing electrode.

2. The sensing electrode pattern as set forth in claim 1, wherein the plurality of sensing electrodes are each formed to have a linear bar shape.

3. The sensing electrode pattern as set forth in claim 1, wherein the plurality of auxiliary electrodes are arranged by a predetermined interval in a longitudinal direction of the plurality of sensing electrodes of the touch panel.

4. The sensing electrode pattern as set forth in claim 1, wherein the plurality of auxiliary electrodes are alternately formed, wherein auxiliary electrodes formed on adjacent sensing electrodes are alternately disposed.

5. The sensing electrode pattern as set forth in claim 1, wherein the plurality of sensing electrodes and the plurality of auxiliary electrodes are formed of a conductive polymer or a metal oxide.

6. The sensing electrode pattern as set forth in claim 1, wherein the plurality of auxiliary electrodes are each formed to have a triangular plate shape.

7. The sensing electrode pattern as set forth in claim 6, wherein the plurality of auxiliary electrodes are formed such that a width of each auxiliary electrode tapers away from each sensing electrode.

8. The sensing electrode pattern as set forth in claim 1, wherein the plurality of auxiliary electrodes are each formed to have a linear bar shape.

9. The sensing electrode pattern as set forth in claim 8, wherein an end of each auxiliary electrode is formed to have a circular plate shape.

10. The sensing electrode pattern as set forth in claim 8, wherein each auxiliary electrode is bent at a predetermined angle.
